(19) United States
(12) Patent Application Publication
(10) Pub. No.: US 2004/0253864 A1
(43) Pub. Date: Dec. 16, 2004

(54) WATERTIGHT CONNECTOR-MODULE ASSEMBLY

(75) Inventors: Josep Maria Roset Rubio, Tarragon Valls (ES); Jordi Torres Butet, Tarragon Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/709,688

(22) Filed: May 22, 2004

(30) Foreign Application Priority Data
Dec. 13, 2002 (WO) PCT/ES02/00595
Jul. 3, 2003 (WO) 03/055010

(51) Int. Cl. H01R 12/00

(52) U.S. Cl. 439/271

(57) ABSTRACT

The invention, sealed connector-module assembly, refers to interchangeable module assemblies of the type in which terminals and cables are introduced with are subsequently introduced in connector devices. These connectors will be subsequently put into contact with other devices, for example, distribution boxes, which also have a number of terminals which come into contact with the terminals introduced in the sealed modules.

### BACKGROUND OF INVENTION

1. Object of the Invention

The present invention, a sealed connector-module assembly, refers to interchangeable module assemblies of the type in which terminals and cables are introduced which are subsequently introduced in connector devices. These connectors are subsequently placed in contact with other devices, for example, distribution boxes which also have a number of terminals which the terminals introduced in the sealed modules come into contact with.

The present invention has a special application in the manufacture and supply sector of electrical connection equipment, such as the case of the auxiliary devices used for the automobile industry.

2. Description of the State of the Art

Currently, easily and quickly carrying out electrical interconnections is a requirement in the majority of auxiliary industries, where a required assembly time reduction has promoted the development of new types of connectors. Said connectors are fundamentally based on the constitution of connection boxes, which can be attached together, provided with closure and retention flaps between both male and female connector parts.

The present invention is proposed as a solution to the need of modular component manufacturing connectors for electrical interconnections, such that it is finally possible to adapt and interchange them for including them in different connectors such that by using different insertable modules in housings provided for such purpose in connectors it is possible to formalize different connections in the same base connector.

By means of the present invention, the number of components to be used is reduced, permitting a large number of combinations for the purpose of achieving optimal configuration in addition to the airtight connection, preventing corrosion problems in the contact areas between terminals.

### DESCRIPTION

The sealed connector-module assembly object of the present invention comprises a module provided with a number of cavities defined by the number of terminals it must house internally, the use of modules with three, six or twelve cavities and one connector body being preferable.

The connector body can have one, two or three housings for housing sealed modules. Connector bodies with two or three housings are provided with a lever on their upper part which, when turned on a shaft, at the same time moves two independent sliding elements with tilted guides, located in two grooves on the sides of said connector, as well as side holes for introducing secondary closure elements for securing proper position of the modules in the housings arranged for them in the connector body. Since the size of the modules is invariable, the thickness or diameter of the terminals will determine the maximum number thereof which can be included in each module.

Around its entire perimeter in the upper part, said modules are provided with a resilient strip providing the module with sealed conditions, preventing oxidation of the terminals in contact since they prevent liquids from passing between the walls of the connector and those of the module.

When housed inside of connector bodies, the modules, together with their terminals already introduced form a single body arranged for its connection with another device. According to the desired connection type, two or three modules can be included in each connector body, in this manner varying the dimensions of said body.

After introducing the modules in the connector and the terminals of the latter coming into contact with the terminals of the other device, it should be checked that the connection is correct and to do so, secondary closure means are provided. Said secondary closure means consist of the introduction of elements with little thickness which pass through the connector body and once inside of the body, are introduced through the grooves existing on the side walls of the modules.

### BRIEF DESCRIPTION OF DRAWINGS

To help better understand the invention, six figures are attached to the present application whose purpose is a better understanding of the principles on which the invention at hand is based, and a better understanding of the description of a preferred embodiment form, taking into account that the character of the figures is illustrative and non-limiting.

FIG. 1 shows two perspective views of a three-track sealed module.

FIG. 2 shows a perspective view of a six-track sealed module.

FIG. 3 shows a perspective view of a twelve-track sealed module.

FIG. 4 shows a perspective view of a connector body internally provided with a compartment or housing for the introduction of a sealed module.

FIG. 5 shows a perspective view of a connector body internally provided with two independent compartments for housing two sealed modules.

FIG. 6 shows a perspective view of a connector body internally provided with three independent compartments for housing three sealed modules.

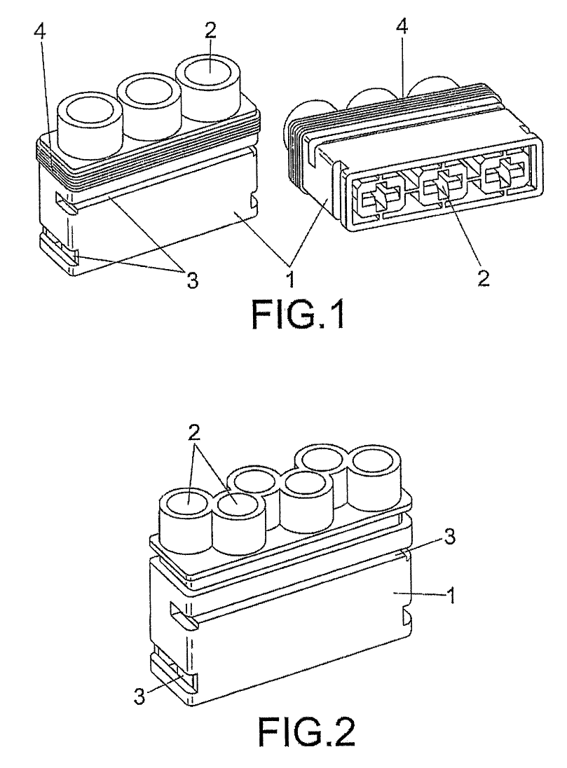

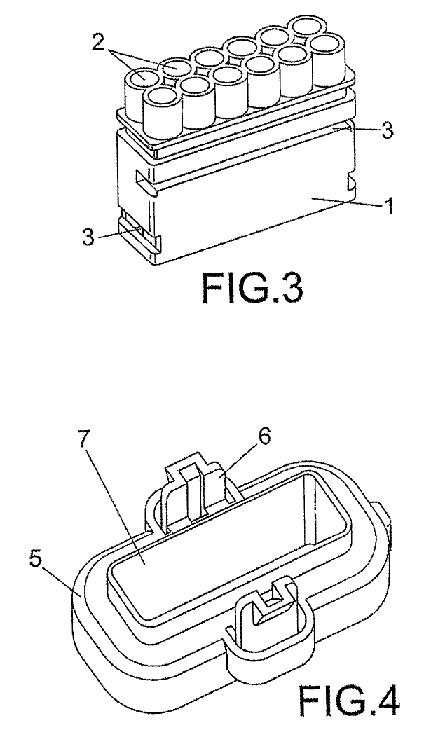

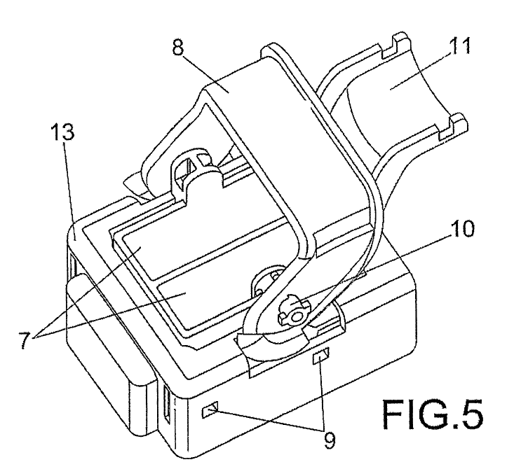

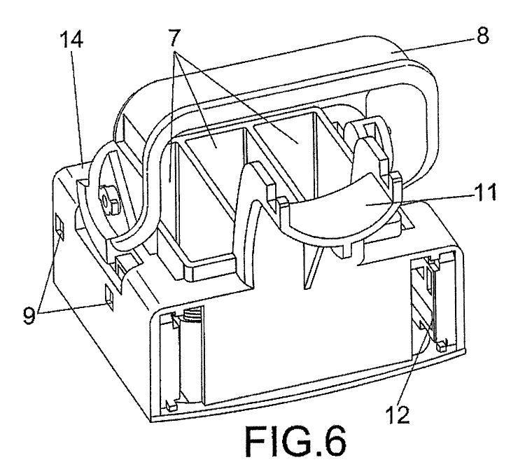

### DETAILED DESCRIPTION

The sealed connector-module assembly has a special application for the coupling between a connector body 5, internally provided with one or more modules 1 incorporating a certain number of terminals associated with the same number of cables, and a base body also provided with terminals for their connecting to those arranged on the connector body 5.

The sealed module 1 can have three, six or twelve cavities or input tracks 2 and the same number of cavities or output tracks 2 intended for housing electric terminals and their cables, the number thereof 2 being determined by the diameter of the terminals to be used in the connection. Specifically, modules 1 having three tracks 2 can be used for housing three 6.3 mm terminals, modules 1 with six tracks 2 for housing six 2.8 mm terminals, modules 1 with twelve tracks 2 for housing twelve 1.5 mm terminals, and modules 1 with twelve tracks 2 for housing twelve 0.635 mm terminals.

Said modules 1 are introduced inside of the housings 7 arranged in connector bodies 5, 13 and 14 intended for such purpose. There are three types of connectors for housing said modules 1, some connectors 5 only housing one module 1 of any of those described above, other connectors 13 which can house two of any of those modules 1 described above, and other connectors 14 which can house three of any of the modules 1 of those described above.

The connector body 5 housing only one module 1 is provided with side flaps 6 for carrying out the connection with the base body of another device.

Connector bodies which can house two 13 or three 14 modules 2 comprise on their upper part a U-shaped support 11 and a lever 8 which turns with regard to pivots 10 and which is in contact with sliding elements 12 with tilted guides which move in two side grooves. The support 11 serves so that once the lever 8 is turned, the cables remain between both elements, being able to route the bundle of cables, and keeping the cables arranged. Under the lever 8 and inside of the connector body, two or three housings 7 are arranged for introducing modules 1 in said connector body 13, 14.

The connector body 13, 14 is assembled with a base body of another device, which is provided with at least two projections on its side walls intended for being introduced into the guides existing on the sliding elements 12 of the connector body 13, 14, which elements 12, when turning the lever 8 clockwise with regard to the pivots 10, horizontally move, being introduced inside of connector body 13, 14 at the same time the projections of the base body move along the guides existing on said sliding elements 12, thus causing the connection of both bodies, the connector body 13, 14 and base body.

In order to protect the connection area between terminals from corrosion, a resilient strip 4 is arranged around the perimeter of the upper part of each module, providing each module and the connections between the terminals with sealed conditions.

Once the connection is carried out between the connector body 5, 13, 14 with the module 2 or modules 2 in their housings 7 and the base body, secondary closure devices are introduced through holes 9 arranged on the side walls of the connector 5, 13, 14. The purpose of said devices is to ensure proper placement of the modules 2 on the inside 7 of the connector body 5, 13, 14, and therefore to verify the proper connection between the terminals of the connector body 5, 13, 14 and base body. Said devices consist of elongated elements with little thickness which pass through the walls of the connector assembly and slide along grooves 3 made on the side walls of the modules.

Within its essence, the invention can be carried out in other embodiments forms differing only in details from the embodiment indicated only as an example. The invention could therefore be carried out in any shape and size, with the most suitable means and materials and with the most suitable accessories, being able to replace the component elements with other technically equivalent component elements, as all of this is comprised within the claims.

1. A sealed connector-module assembly, of the type used for coupling between a connector body, provided with a certain number of terminals which are associated with the same number of cables, to a base body also provided with terminals for their connecting to those arranged on the connector body, characterized in that the sealed module is provided with at least three cavities or input tracks and the same number of cavities our output tracks intended for housing electric terminals and their cables, having a resilient band around the perimeter of the upper part of the module providing it with sealed conditions for its subsequent introduction in a connector body housing.

2. A sealed connector-module assembly according to claim 1, characterized in that the connector body is provided with one housing for the introduction of a single module.

3. A sealed connector-module assembly according to claim 1, characterized in that the connector body is provided on its upper part with a U-shaped support, a lever which turns with regard to pivots and is in contact with sliding elements, and has housings for introducing modules in said connector body, also having two side grooves through which respective sliding elements with inclined guides run, said connector body being designed to be assembled with a base body, said base body having at least two projections in its side walls intended for being introduced in the guides existing on the sliding elements of the connector body, elements which, when turning the lever clockwise with regard to the pivots, move horizontally, being introduced inside of the connector body at the same time the projections of the base body run along the guides existing on said sliding elements, causing the connection of both bodies and provided on its side walls with at least two holes for introducing secondary closure devices.

4. A sealed connector-module assembly according to claim 3, characterized in that the connector is provided with two housings for introducing two modules.

5. A sealed connector-module assembly according to claim 3, characterized in that the connector is provided with three housings for introducing three modules.

6. A sealed connector-module assembly according to claim 1, characterized in that the module is provided with side grooves which permit securing proper placement of the module in the connector body by means of introducing secondary closure devices into said connector body.

7. A sealed connector-module assembly according to claim 1, characterized in that the number of tracks is determined by the diameter of the terminals to be housed in the module.

8. A sealed connector-module assembly according to claims 1 and 7, characterized in that the module is provided with three tracks for housing three 6.3 mm terminals in diameter.

9. A sealed connector-module assembly according to claim 1, characterized in that it is provided with six tracks for housing six 2.8 mm terminals in diameter.

10. A sealed connector-module assembly according to claim 1, characterized in that it is provided with twelve tracks for housing twelve 1.5 mm terminals in diameter.

11. A sealed connector-module assembly according to claim 1, characterized in that it is provided with twelve tracks for housing twelve 0.635 mm terminals in diameter.

12. A sealed connector-module assembly according to claim 7, characterized in that it is provided with six tracks for housing six 2.8 mm terminals in diameter.

13. A sealed connector-module assembly according to claim 7, characterized in that it is provided with twelve tracks for housing twelve 1.5 mm terminals in diameter.

14. A sealed connector-module assembly according to claim 7, characterized in that it is provided with twelve tracks for housing twelve 0.635 mm terminals in diameter.
